(19) United States
(12) Patent Application Publication
(10) Pub. No.: US 2016/0309780 A1
(43) Pub. Date: Oct. 27, 2016

(54) ELECTRONIC CIGARETTE MICROPHONE SUPPORTING WIRELESS CHARGING, AND CHARGING METHOD AND DEVICE FOR ELECTRONIC CIGARETTE MICROPHONE

(71) Applicant: Sigma Microelectronics Co., Ltd., Beijing (CN)

(72) Inventors: Bingjie Chen, Beijing (CN); Lun LV, Shenzhen (CN)

(21) Appl. No.: 14/924,346

(22) Filed: Oct. 27, 2015

(30) Foreign Application Priority Data
Apr. 24, 2015 (CN) 201510202570.3

(51) Int. Cl. A24F 47/00; H02J 7/00; H05B 1/02

(52) U.S. Cl. CPC A24F 47/008; H05B 1/0244; H02J 7/0052; H02J 7/007

(57) ABSTRACT

The disclosure discloses an electronic cigarette microphone supporting wireless charging, and a charging method and device for the electronic cigarette microphone. The electronic cigarette microphone includes: a charging port, electrically connected with a receiving coil and configured to receive alternating current generated by the induction of the receiving coil and a transmitting coil; a control device, connected with the charging port and configured to convert the alternating current into charging current; an output port, connected with the control device and a rechargeable battery of an electronic cigarette respectively and configured to output the charging current to the rechargeable battery; an atomization terminal, connected with the control device and an atomizer of the electronic cigarette respectively and configured to output an atomization triggering signal for driving the atomizer; and a grounding terminal, connected with the control device. By the electronic cigarette microphone supporting wireless charging in the invention, the number of pins of the electronic cigarette microphone supporting wireless charging is reduced, the problem that larger size of the electronic cigarette microphone supporting wireless charging in the existing technology is solved, and the effect that reducing the size of the electronic cigarette microphone supporting wireless charging is achieved.

### FIELD

The disclosure relates to the electronic cigarettes field, and in particular to an electronic cigarette microphone supporting wireless charging, and a charging method and device for the electronic cigarette microphone.

### BACKGROUND

An electronic cigarette, also called an electronic Xiangyan, has the same shape and appearance as an ordinary cigarette, and is mainly used for smoking cessation and use instead of a cigarette. An electronic cigarette microphone is an important part of an electronic cigarette, and an existing electronic cigarette microphone supporting wireless charging is complex in structure and larger in size, and may occupy finite space capacity of the electronic cigarette; and in addition, when the existing electronic cigarette microphone supporting wireless charging is used, a peripheral circuit of the electronic cigarette microphone is relatively complex, which may causes influence on stability of an electronic cigarette product.

For the problem that larger size of the electronic cigarette microphone supporting wireless charging in an existing technology, there is yet no effective solution.

### SUMMARY

The embodiment of the disclosure provides an electronic cigarette microphone supporting wireless charging, and a charging method and device for the electronic cigarette microphone, so as to at least solve the technical problem of larger size of an electronic cigarette microphone supporting wireless charging in the existing technology.

According to one aspect of the embodiment of the invention, an electronic cigarette microphone supporting wireless charging is provided, which includes: a charging port, electrically connected with a receiving coil and configured to receive alternating current generated by the induction of the receiving coil and a transmitting coil; a control device, connected with the charging port and configured to convert the alternating current into charging current; an output port, connected with the control device and a rechargeable battery of an electronic cigarette respectively and configured to output the charging current to the rechargeable battery; an atomization terminal, connected with the control device and an atomizer of the electronic cigarette respectively and configured to output an atomization triggering signal for driving the atomizer; and a grounding terminal, connected with the control device.

According to another aspect of the embodiment of the disclosure, a charging method for an electronic cigarette microphone supporting wireless charging is further provided, which includes: receiving alternating current generated by the induction of a receiving coil and transmitting coil of an electronic cigarette; converting the alternating current into direct-current charging current; and outputting the direct-current charging current to a rechargeable battery of the electronic cigarette.

According to another aspect of the embodiment of the disclosure, a charging device for an electronic cigarette microphone supporting wireless charging is further provided, which includes: a receiving unit, configured to receive alternating current generated by the induction of a receiving coil and transmitting coil of an electronic cigarette; a current conversion unit, configured to convert the alternating current into direct-current charging current; and an output unit, configured to output the direct-current charging current to a rechargeable battery of the electronic cigarette.

According to the electronic cigarette microphone supporting wireless charging in the invention, the charging port is used for receiving the alternating current generated by the induction of the receiving coil and the transmitting coil, then the control device converts the alternating current into direct-current charging current, and the direct-current charging current is output to charge the rechargeable battery through the output port. By the invention, an alternating current and direct current conversion device and the like are integrated in the control device, so that the number of pins of the electronic cigarette microphone supporting wireless charging is reduced, the problem that larger size of the electronic cigarette microphone supporting wireless charging in the existing technology is solved, and the effect that reducing the size of the electronic cigarette microphone supporting wireless charging is achieved.

### BRIEF DESCRIPTION OF THE DRAWINGS

The drawings are described here to provide further understanding of the invention, and form a part of the invention. The schematic embodiments and description of the disclosure are adopted to explain the disclosure, and do not form improper limits to the disclosure. In the drawings:

FIG. 1 is a diagram of an electronic cigarette microphone supporting wireless charging according to an embodiment of the invention;

FIG. 2 is a diagram of another electronic cigarette microphone supporting wireless charging according to an embodiment of the invention;

FIG. 3 is a diagram of a third electronic cigarette microphone supporting wireless charging according to an embodiment of the invention;

FIG. 4 is a diagram of a fourth electronic cigarette microphone supporting wireless charging according to an embodiment of the invention;

FIG. 5 is a diagram of an external structure of an electronic cigarette microphone supporting wireless charging according to an embodiment of the invention;

FIG. 6 is a flowchart of a charging method for an electronic cigarette microphone supporting wireless charging according to an embodiment of the invention; and

FIG. 7 is a diagram of a charging device for an electronic cigarette microphone supporting wireless charging according to an embodiment of the invention.

### DETAILED DESCRIPTION OF THE EMBODIMENTS

In order to make those skilled in the art better understand the solutions of the invention, the technical solutions in the embodiments of the invention are clearly and completely described below with reference to the drawings in the embodiments of the invention, and obviously, the described embodiments are only a part of embodiments of the invention, and are not all the embodiments. Based on the embodiments of the invention, all the other embodiments obtained by those skilled in the art on the premise of no creative work shall fall within the scope of protection of the invention.

It should be noted that the terms “first”, “second” and the like in the Specification, claims and drawings of the invention are adopted to distinguish similar objects and are not required to be used for describing a specific sequence or an order. It should be understood that data used like that can be interchanged under a proper condition, so that the embodiments of the invention described here can be implemented in a sequence different from those shown or described here. In addition, terms “include” and “have” and any their deformation are intended to cover non-exclusive inclusion, for example, a process, method, system, product or equipment including a series of steps or units is not limited to the clearly listed steps or units, but may include other steps or units which are not clearly listed or are intrinsic for the process, method, product or equipment.

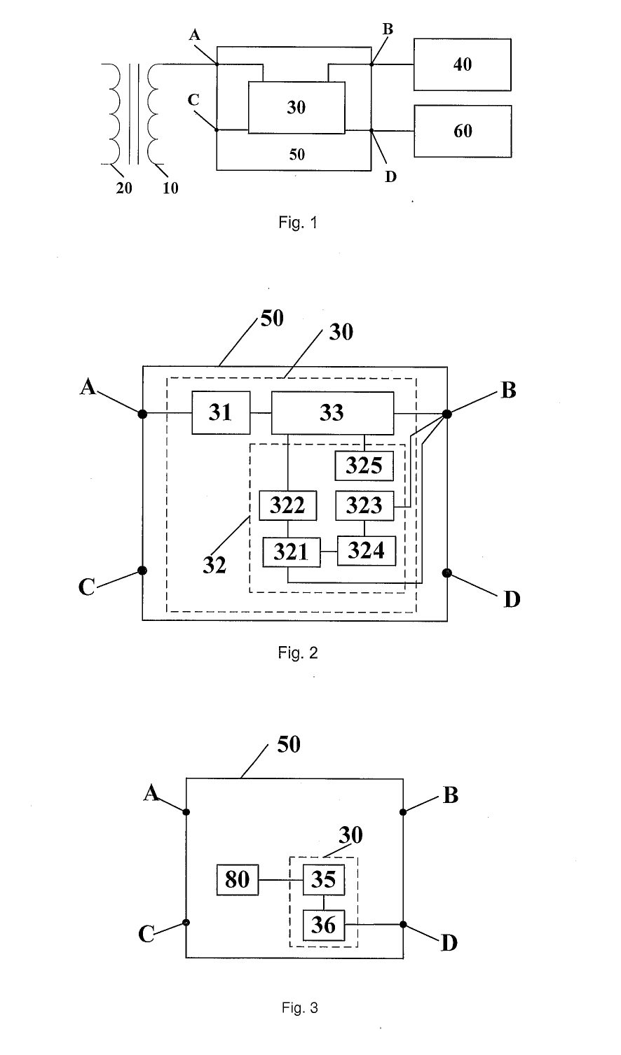

FIG. 1 is a diagram of an electronic cigarette microphone supporting wireless charging according to an embodiment of the disclosure, and as shown in FIG. 1, the electronic cigarette microphone 50 includes: a charging port A, a control device 30, an output port B, a grounding terminal C and an atomization terminal D.

Wherein, the charging port A is electrically connected with a receiving coil 10, and is configured to receive alternating current generated by the induction of the receiving coil 10 and a transmitting coil 20; the control device 30 is connected with the charging port A, and is configured to convert the alternating current into charging current; the output port B is connected with the control device 30 and a rechargeable battery 40 of an electronic cigarette respectively, and is configured to output the charging current to the rechargeable battery; the atomization terminal D is connected with the control device 30 and an atomizer of the electronic cigarette respectively, and is configured to output an atomization triggering signal for driving the atomizer 60; and the grounding terminal C is connected with the control device 30.

According to the electronic cigarette microphone supporting wireless charging in the invention, the charging port is used for receiving the alternating current generated by the induction of the receiving coil and the transmitting coil, then the control device converts the alternating current into direct-current charging current, and the direct-current charging current is output to charge the rechargeable battery through the output port. By the disclosure, an alternating current and direct current conversion device and the like are integrated in the control device, so that the number of pins of the electronic cigarette microphone supporting wireless charging is reduced, the problem that larger size of the electronic cigarette microphone supporting wireless charging in the existing technology is solved, and the effect that reducing the size of the electronic cigarette microphone supporting wireless charging is achieved.

It should be noted that the direct-current charging current may be pulse current or trickle current, but not limited to pulse current or trickle current, and the grounding terminal may be directly connected with a housing of the electronic cigarette; and the atomization terminal may further output driving current for driving the atomizer to work while the output of the atomization triggering signal.

In the embodiment, the control device 30 may include a rectification circuit 31 shown in FIG. 2, connected between the charging port A and the output port B and configured to convert the alternating current into the direct-current charging current.

Wherein, a function of the rectification circuit may be realized by virtue of a high-voltage rectification power tube.

Due to the adoption of the electronic cigarette microphone supporting wireless charging, which includes four pins, i.e. the charging port, the output port, the grounding terminal and the atomization terminal, provided by the invention, the number of the pins of the electronic cigarette microphone is reduced, the size of the electronic cigarette microphone supporting wireless charging can be effectively reduced; and the electronic cigarette microphone can work only by constructing a simple peripheral circuit on the basis of the four pins; and the peripheral circuit is simple, and a control manner is also relatively simple, so that the whole circuit can work more stably and reliably.

Preferably, as shown in FIG. 2, the control device 30 may further include: a switching controller 32, connected with the rechargeable battery through the output port and configured to generate a switching triggering signal when power of the rechargeable battery reaches preset power and/or temperature of the control device reaches first preset temperature; and a switching circuit 33, connected with the switching controller, and the switching circuit connected between the rectification circuit and the output port and configured to disconnect the connection between the rectification circuit and the output port when receiving the switching triggering signal. In the embodiment, as shown in FIG. 2, the switching controller 32 may include: a power detection circuit 321, connected with the rechargeable battery through the output port and configured to detect the power of the rechargeable battery; a power comparison circuit 322, connected with the power detection circuit and the switching circuit respectively and configured to generate the switching triggering signal when the power of the rechargeable battery reaches the preset power; and/or a first temperature detector 325, connected with the switching circuit and configured to detect the temperature of the control device and generate the switching triggering signal when the temperature reaches the first preset temperature. Wherein, the first temperature detector is integrated to the control device, or the first temperature detector is arranged in the control device.

It should be noted that if the control device is a control chip (such as a single-chip microcomputer), the first temperature detector may be a temperature detection unit integrated into the control chip; and if the control device is a control circuit, the first temperature detector may be a temperature detection sensor arranged on the control circuit.

Preferably, as shown in FIG. 2, the switching controller 32 may further include: a timer 323, connected with the rechargeable battery through the output port and configured to time the charging time of the rechargeable battery; and a signal generator 324, connected between the timer and the power detection circuit and configured to generate a starting signal for starting the power detection circuit and/or the first temperature detector when the charging time reaches preset time.

It should be noted that FIG. 2 further shows the electronic cigarette microphone 50 supporting wireless charging and its grounding terminal C and atomization terminal D.

Optionally, the signal generator may be connected with the first temperature detector.

Specifically, when the charging time reaches the preset time (for example, 5 minutes), the first temperature detector detects own temperature of the control device, the power detection circuit detects the power of the rechargeable battery, and when the temperature of the control device reaches the preset temperature (for example, 150 DEG C.) or the power of the rechargeable battery reaches the preset power (for example, the battery has been fully charged), the signal generator generates the switching triggering signal to disconnect the rectification circuit from the output port to stop charging so as to protect the rechargeable battery.

It should be noted that the power comparison circuit is further configured to control the switching circuit to connect the rectification circuit with the output port to continue charging the rechargeable battery when the detected power of the rechargeable battery is lower than the preset power and the detected temperature of the control device is lower than the first preset temperature.

Optionally, the switching circuit further has a direct current chopping function. The switching circuit is further configured to regulate a current value of the output charging current according to the power of the rechargeable battery, optionally increase the output charging current when the power is far lower than the preset power and reduce the output charging current when the power is close to the preset power.

In an optional implementation mode of the invention, the control device is connected with the switching circuit, the control device acquires a current value corresponding to the currently detected power of the rechargeable battery, and generates a current regulation signal corresponding to the current value, and the switching circuit is triggered by the current regulation signal to output corresponding charging current with the current value.

During charging, the switching circuit connects the rectification circuit with the output port, the alternating current generated by the induction of the receiving coil and the transmitting coil is received through the charging port, the rectification circuit converts the alternating current into the direct-current charging current, and the charging current is output to charge the rechargeable battery through the output port.

Optionally, when the switching circuit connects the rectification circuit with the output port to start charging the rechargeable battery, the charging time of the rechargeable battery is timed, and when the charging time reaches the preset time (for example, 5 minutes), the power of the rechargeable battery is detected, and the magnitude of the charging current output by the power switching circuit is regulated according to the power of the rechargeable battery: when the power of the rechargeable battery is relatively low (for example, the power of the battery is lower than 50 percent), first preset charging current is output to accelerate the charging of the rechargeable battery; when the power of the rechargeable battery is relatively high (for example, the power of the battery is higher than 90 percent), second preset charging current is output to prevent the rechargeable battery from being damaged by excessively high charging current; and when the power of the rechargeable battery reaches the preset power (for example, the power of the battery reaches 100 percent), charging is stopped. Wherein, a value of the first preset charging current is greater than a value of the second preset charging current.

According to the embodiment, the rechargeable battery can be wirelessly charged only by being connected to the output port of the electronic cigarette microphone supporting wireless charging without an additional charging circuit, so that the size of the electronic cigarette can be reduced.

In the embodiment, as shown in FIG. 3, the control device 30 may further include: a detector 35, connected with an airflow detection capacitor 80 of the electronic cigarette and configured to detect a capacitance change value of the airflow detection capacitor; and an atomization controller 36, connected with the detector and the atomization terminal D respectively and configured to generate the atomization triggering signal when the capacitance change value of the airflow detection capacitor reaches a preset change value.

It should be noted that FIG. 3 further shows the electronic cigarette microphone 50 supporting wireless charging and its charging port A, output port B and grounding terminal C.

In the embodiment, the control device may further include: a second temperature detector, connected with the atomization controller and configured to generate a triggering signal for stopping the work of the atomizer if the temperature of the control device is detected to reach second preset temperature when the atomizer works.

It should be noted that the second temperature detector and the first temperature detector may be the same temperature detector.

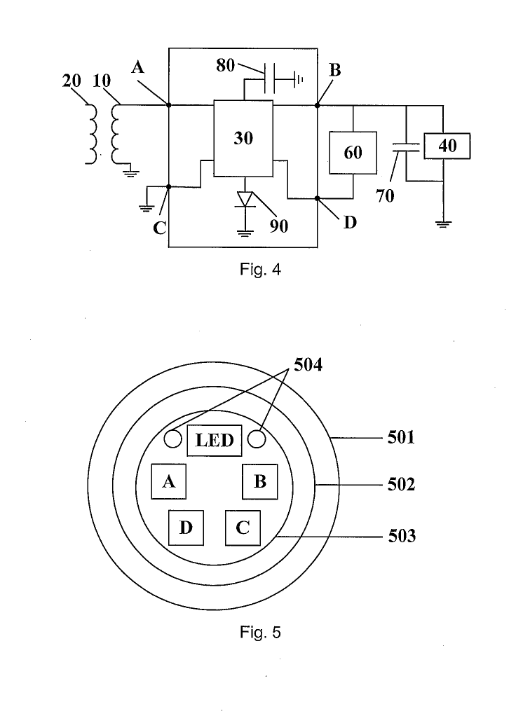

Optionally, as shown in FIG. 4, the electronic cigarette microphone supporting wireless charging in the invention may further include: a Light-Emitting Diode (LED) 90, connected with the control device and configured to emit light when receiving a display triggering signal of the control device 30.

It should be noted that, as shown in FIG. 5 (FIG. 5 shows a diagram of an external structure of the electronic cigarette microphone), a plastic diaphragm 502 and an SW metal layer 503 are arranged in the metal housing 501 of the electronic cigarette, and the airflow detection capacitor 80 (not shown in FIG. 5) is arranged between the SW metal layer and the plastic diaphragm, and is connected with the detector (a connecting relationship of the airflow detection capacitor is not shown in FIG. 5). One electrode of the airflow detection capacitor is a deformable conductor (the deformable conductor is connected with the control device through a pin of the control device), the other electrode of the airflow detection capacitor is the grounded metal housing of the electronic cigarette, and when there is airflow flowing through the electronic cigarette microphone, the distance between the two electrodes (i.e. anode and cathode) of the airflow detection capacitor may be changed, and a capacitance value may further be changed. The change of the capacitance value may be converted into a change of frequency (such as voltage frequency or current frequency) through an internal detection circuit (i.e. the detector), and when the variation reaches the preset change value, the atomizer is triggered to work. In addition, in order to overcome the influence of an environment on the sensitivity of the electronic cigarette microphone, the preset change value of the airflow detection capacitor may be automatically regulated according to an environmental change.

Specifically, when the atomizer works, the second temperature detector detects the temperature of the control device in real time, and when the temperature of the control device reaches the second preset temperature (for example, 150 DEC C.), the triggering signal is generated to stop the work of the atomizer, thereby preventing the electronic cigarette from overtemperature.

It should be noted that an air vent 504 (shown in FIG. 5) is further formed in the electronic cigarette microphone supporting wireless charging in the invention, FIG. 5 further shows the charging port A, the output port B, the atomization terminal D and the grounding terminal C, and the LED shown in FIG. 5 is the light-emitting diode.

The embodiment of the invention is described below with reference to FIG. 4 in detail.

FIG. 4 shows the electronic cigarette microphone supporting wireless charging in the invention and its peripheral circuit, and as shown in FIG. 4, the grounding terminal C of the electronic cigarette microphone is grounded. When the electronic cigarette microphone works, the receiving coil 10 receives the alternating current generated by the induction of the receiving coil 10 and the transmitting coil 20, the control device 30 receives the alternating current through the charging port A, and converts the alternating current into direct-current charging current, the charging current is output to charge the rechargeable battery 40 through the output port B, and a protective capacitor 70 is configured to protect the charging current when the rechargeable battery is charged and discharged. When a user uses the electronic cigarette after the rechargeable battery is charged, the capacitance value of the airflow detection capacitor of the electronic cigarette may be changed, the control device generates the atomization triggering signal to trigger the atomizer 60 to work which is connected with the atomization terminal D of the electronic cigarette microphone when the capacitance change value of the airflow detection capacitor 80 is detected to be higher than the preset change value, and controls the LED 90 to emit light, the atomizer heats to volatilize smoking oil through a heating device, the second temperature detector detects the temperature of the control device in real time when the atomizer works, and when the temperature reaches the second preset temperature (for example, 150 DEG C.), the triggering signal is generated to stop the work of the atomizer, thereby preventing the electronic cigarette from overtemperature.

It should further be noted that the first end of the protective capacitor 70 is connected with the cathode of the rechargeable battery, the second end of the protective capacitor 70 is connected with the anode of the rechargeable battery, the protective capacitor 70 is configured to prevent a sudden change of voltage of the two ends of the rechargeable battery to protect the rechargeable battery, and in addition, the protective capacitor further has a high-order harmonic filtering function.

According to the embodiment, a charging terminal of the electronic cigarette microphone supporting wireless charging in the invention is connected with the receiving coil, an output terminal is connected with the rechargeable battery, the grounding terminal is grounded, and the atomization terminal is connected with the atomizer, that is, functions of wireless charging, smoking oil heating and the like can be realized only by arranging a simple circuit on the basis of the four terminals of the electronic cigarette microphone, and the size of the electronic cigarette microphone supporting wireless charging can be effectively reduced on the premise of realizing wireless charging.

According to the embodiment of the invention, a method embodiment of a charging method for an electronic cigarette microphone supporting wireless charging is provided. It should be noted that steps shown in the flowchart in the drawings can be executed in a computer system, such as a group of computers, capable of executing instructions, moreover, although a logic sequence is shown in the flowchart, the shown or described steps may be executed in a sequence different from the logic sequence under a certain condition.

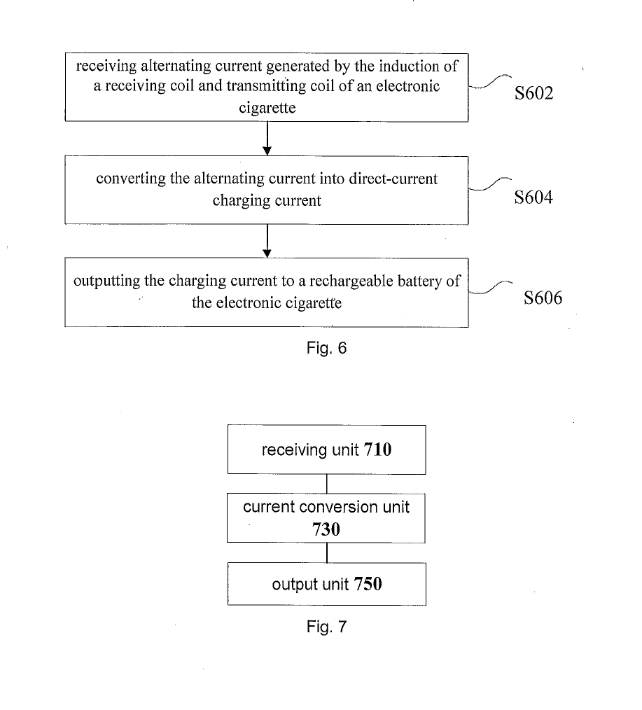

FIG. 6 is a flowchart of a charging method for an electronic cigarette microphone supporting wireless charging according to an embodiment of the invention, and as shown in FIG. 6, the method includes the following steps:

Step 602: receiving alternating current generated by the induction of a receiving coil and transmitting coil of an electronic cigarette;

Step 604: converting the alternating current into direct-current charging current; and

Step 606: outputting the charging current to a rechargeable battery of the electronic cigarette.

According to the embodiment, the alternating current generated by the induction of the receiving coil and transmitting coil of the electronic cigarette is received, the alternating current is converted into direct-current charging current through the electronic cigarette microphone supporting wireless charging, and the charging current is used for charging the rechargeable battery of the electronic cigarette. By the electronic cigarette microphone supporting wireless charging in the invention, the number of pins of the electronic cigarette microphone supporting wireless charging can be reduced, the problem that larger size of the electronic cigarette microphone supporting wireless charging in the existing technology is solved, and the effect that reducing the size of the electronic cigarette microphone supporting wireless charging is achieved.

In the embodiment, the step of outputting the charging current to a rechargeable battery of the electronic cigarette may include: when charging time of the rechargeable battery reaches preset time, detecting power of the rechargeable battery; if the power of the rechargeable battery is lower than preset power, continuing charging the rechargeable battery; and if the power of the rechargeable battery reaches the preset power, stopping charging.

Specifically, the electronic cigarette microphone receives the alternating current (i.e. alternating current induced voltage) generated by the induction of the receiving coil and the transmitting coil through a charging port, a high-voltage rectification power tube in the electronic cigarette microphone is used for converting the alternating current into the direct-current charging current, and the charging current is used for charging the rechargeable battery. In a charging process, the power of the rechargeable battery is detected in real time, and when the power of the rechargeable battery is lower than the preset power, the rechargeable battery is continuously charged; and when the power of the rechargeable battery reaches the preset power, charging is stopped.

According to the embodiment, when the rechargeable battery is wirelessly charged, its power can be detected in real time, and when the power reaches a preset power value, charging is stopped to avoid overcharging, thereby better protecting the battery and prolonging its service life.

Optionally, after stopping charging, the charging method may further include: detecting an airflow change value in a smoke tube of the electronic cigarette; and when the airflow change value is higher than a preset threshold value, triggering an atomizer of the electronic cigarette to work.

Specifically, when the electronic cigarette microphone supporting wireless charging in the invention works, a capacitance value (such as frequency of the capacitor) of an airflow detection capacitor of the electronic cigarette may be changed, the airflow change value can be determined by virtue of the capacitance change value, an atomization triggering signal is generated to trigger the atomizer to work when the airflow change value reaches the preset threshold value, and the atomizer heats smoking oil to volatilize the smoking oil through its internal heating device.

It should further be noted that an LED of the electronic cigarette is controlled to emit light when the atomizer works, and when the atomizer stops working, the LED of the electronic cigarette is controlled to be turned off.

It should be noted that a series of operation is described as a combination in each abovementioned method embodiment for simple description, but those skilled in the art should know that the invention is not limited by the described operation sequence, so that some steps may be implemented in another sequence or at the same time according to the invention. Then, those skilled in the art should also know that the embodiments described in the invention are all preferred embodiments, and involved operations and modules are not necessary for the invention.

FIG. 7 is a diagram of a charging device for an electronic cigarette microphone supporting wireless charging according to an embodiment of the invention, and as shown in FIG. 7, the device includes: a receiving unit 710, a current conversion unit 730 and an output unit 750.

Wherein, the receiving unit 710 is configured to receive alternating current generated by the induction of a receiving coil and transmitting coil of an electronic cigarette; the current conversion unit 730 is configured to convert the alternating current into direct-current charging current; and the output unit 750 is configured to output the direct-current charging current to a rechargeable battery of the electronic cigarette.

According to the embodiment, the receiving unit receives the alternating current generated by the induction of the receiving coil and transmitting coil of the electronic cigarette, the alternating current is converted into the direct-current charging current through the current conversion unit, and the output unit charges the rechargeable battery of the electronic cigarette by virtue of the charging current. By the electronic cigarette microphone supporting wireless charging in the invention, the number of pins of the electronic cigarette microphone can be reduced, the problem that larger size of the electronic cigarette microphone supporting wireless charging in the existing technology is solved, and the effect that reducing the size of the electronic cigarette microphone supporting wireless charging is achieved.

It should further be noted that the receiving unit, the current conversion unit and the output unit correspond to Step 602 to Step 606 in the method embodiment, and examples and application scenarios of the three units are the same as those implemented by the corresponding steps, but not limited to contents disclosed in the method embodiment.

It should noted that the units, as a part of the device, may run in a computer terminal, may be implemented through software, and may also be implemented through hardware, for example, the function of the receiving unit may be realized through the charging port in the abovementioned embodiment, the function of the current conversion unit may be realized through the rectification circuit in the abovementioned embodiment, and the function of the output unit may be realized through the output port in the abovementioned embodiment.

In the embodiment, the output unit may include: a power detection module, configured to detect power of the rechargeable battery when charging time of the rechargeable battery reaches preset time; a charging module, configured to continue charging the rechargeable battery if the power of the rechargeable battery is lower than preset power; and a powering-off module, configured to stop charging if the power of the rechargeable battery reaches the preset power.

Optionally, the charging device may further include: an airflow detection module, configured to detect an airflow change value in a smoke tube of the electronic cigarette after charging is stopped; and a control module, configured to trigger an atomizer of the electronic cigarette to work when the airflow change value is higher than a preset threshold value.

Specifically, the receiving unit is used for receiving the alternating current (i.e. alternating current induced voltage) generated by the induction of the receiving coil and the transmitting coil, the current conversion unit is used for converting the alternating current into the direct-current charging current, and the output unit charges the rechargeable battery by virtue of the charging current. In a charging process, the power of the rechargeable battery is detected in real time, and when the power of the rechargeable battery is lower than the preset power, the rechargeable battery is continuously charged; and when the power of the rechargeable battery reaches the preset power, charging is stopped. When the electronic cigarette microphone works, a capacitance value (such as frequency of the capacitor) of an airflow detection capacitor of the electronic cigarette may be changed, the airflow change value can be determined by virtue of a capacitance change value, an atomization triggering signal is generated to trigger the atomizer to work when the airflow change value reaches a preset threshold value, and at the same time, an LED of the electronic cigarette is controlled to emit light, and the atomizer heats to volatilize smoking oil through its internal heating device. When the atomizer stops working, the LED of the electronic cigarette is controlled to be turned off.

According to the embodiment, when the rechargeable battery is charged, its power is detected in real time, and when the power reaches a preset power value, charging is stopped to avoid overcharging, thereby better protecting the battery and prolonging its service life.

The sequence numbers in the embodiments of the invention are adopted for description only, and do not represent the superiority-inferiority of the embodiments.

In the embodiments of the invention, extra emphasis is placed on the description of each embodiment, and for parts not described in detail in certain embodiments, see related description in the other embodiments.

From the embodiments provided by the invention, it should be understood that the disclosed technical contents may be implemented in other manners. Wherein, the device embodiment described above is only schematic, for example, division of the units may be logic function division, and there are other division manners during practical implementation, for example, multiple units or components can be combined or integrated to another system, or some characteristics can be neglected, or not executed. In addition, the displayed or discussed mutual coupling or direct coupling or communication connection may be indirect coupling or communication connection implemented through some interfaces, units or modules, and may be implemented electrically or in other forms.

The units described as separate parts may be or may not be physically separated, and the parts displayed as units may be or may not be physical units, that is, the parts may be positioned at the same place, or may be distributed on multiple units. A part or all of the units can be selected to fulfil the aims of the solutions of the embodiments according to actual needs.

In addition, each functional unit in each embodiment of the invention may be integrated in a processing unit, and may independently and physically exist, and two or more than two units are integrated in a unit. The integrated units may be implemented in a form of hardware, and may also be implemented in form of software functional unit.

If the integrated units are implemented in form of software function unit and sold or used as independent products, the integrated units may be stored in a computer-readable storage medium. Based on such understanding, the technical solutions of the invention may substantially be or the parts making contributions to the existing technology or all or a part of the technical solutions may be embodied in form of software product, and the computer software product is stored in a storage medium, and includes a plurality of instructions for making a piece of computer equipment (which may be a personal computer, a server, network equipment or the like) execute all or a part of steps of the method in each embodiment of the invention. The storage medium includes: various media capable of storing program codes such as a U disk, a Read-Only Memory (ROM), a Random Access Memory (RAM), a mobile hard disk, a disk or a compact disc.

The above is only the preferred implementation mode of the invention, and it should be pointed out that those skilled in the art may make a plurality of improvements and embellishments without departing from the principle of the invention, and the improvements and embellishments shall be considered within the scope of protection of the invention.

What is claimed is:

1. An electronic cigarette microphone supporting wireless charging, comprising:
a charging port, electrically connected with a receiving coil and configured to receive alternating current generated by the induction of the receiving coil and a transmitting coil;
a control device, connected with the charging port and configured to convert the alternating current into charging current;
an output port, connected with the control device and a rechargeable battery of an electronic cigarette respectively and configured to output the charging current to the rechargeable battery;
an atomization terminal, connected with the control device and an atomizer of the electronic cigarette respectively and configured to output an atomization triggering signal for driving the atomizer; and
a grounding terminal, connected with the control device.

2. The electronic cigarette microphone according to claim 1, wherein the control device comprises:
a rectification circuit, connected between the charging port and the output port and configured to convert the alternating current into the direct-current charging current.

3. The electronic cigarette microphone according to claim 2, wherein the control device comprises:
a switching controller, connected with the rechargeable battery through the output port and configured to generate a switching triggering signal when power of the rechargeable battery reaches a preset power and/or temperature of the control device reaches a first preset temperature; and
a switching circuit, connected with the switching controller, and the switching circuit connected between the rectification circuit and the output port and configured to disconnect the connection between the rectification circuit and the output port when receiving the switching triggering signal.

4. The electronic cigarette microphone according to claim 3, wherein the switching controller comprises:
a power detection circuit, connected with the rechargeable battery through the output port and configured to detect the power of the rechargeable battery;
a power comparison circuit, connected with the power detection circuit and the switching circuit respectively and configured to generate the switching triggering signal when the power of the rechargeable battery reaches the preset power; and/or
a first temperature detector, connected with the switching circuit and configured to detect the temperature of the control device and generate the switching triggering signal when the temperature reaches the first preset temperature,
wherein, the first temperature detector is integrated to the control device, or the first temperature detector is arranged in the control device.

5. The electronic cigarette microphone according to claim 4, wherein the switching controller further comprises:
a timer, connected with the rechargeable battery through the output port and configured to time the charging of the rechargeable battery; and
a signal generator, connected between the timer and the power detection circuit and configured to generate a starting signal for starting the power detection circuit and/or the first temperature detector when the charging time reaches preset time.

6. The electronic cigarette microphone according to claim 1, wherein the control device further comprises:
a detector, connected with an airflow detection capacitor of the electronic cigarette and configured to detect a capacitance change value of the airflow detection capacitor; and
an atomization controller, connected with the detector and the atomization terminal respectively and configured to generate the atomization triggering signal when the capacitance change value of the airflow detection capacitor reaches a preset change value.

7. The electronic cigarette microphone according to claim 6, wherein the control device further comprises:
a second temperature detector, connected with the atomization controller and configured to generate a triggering signal for stopping the work of the atomizer if the temperature of the control device is detected to reach a second preset temperature when the atomizer works.

8. The electronic cigarette microphone according to claim 1, further comprising:
a Light-Emitting Diode (LED), connected with the control device and configured to emit light when receiving a display triggering signal of the control device.

9. A charging method for an electronic cigarette microphone supporting wireless charging, comprising:
receiving alternating current generated by the induction of a receiving coil and a transmitting coil of an electronic cigarette;
converting the alternating current into direct-current charging current; and
outputting the direct-current charging current to a rechargeable battery of the electronic cigarette.

10. The charging method according to claim 9, wherein the step of outputting the direct-current charging current to a rechargeable battery of the electronic cigarette comprises:
when charging time of the rechargeable battery reaches preset time, detecting power of the rechargeable battery;
if the power of the rechargeable battery is lower than a preset power, continuing charging the rechargeable battery; and
if the power of the rechargeable battery reaches the preset power, stopping charging.

11. The charging method according to claim 10, after stopping charging, further comprising:
detecting an airflow change value in a smoke tube of the electronic cigarette; and
when the airflow change value is higher than a preset threshold value, triggering the atomizer of the electronic cigarette to work.

12. A charging device for an electronic cigarette microphone supporting wireless charging, comprising:
a receiving unit is configured to receive alternating current generated by the induction of a receiving coil and transmitting coil of an electronic cigarette;
a current conversion unit is configured to convert the alternating current into direct-current charging current; and
an output unit is configured to output the direct-current charging current to a rechargeable battery of the electronic cigarette.
